(19) United States
(12) Patent Application Publication
(10) Pub. No.: US 2025/0217544 A1
(43) Pub. Date: Jul. 3, 2025

(54) STRENGTH PREDICTION METHOD FOR LASER BONDED COMPOSITE MATERIALS

(71) Applicant: INDUSTRIAL TECHNOLOGY RESEARCH INSTITUTE, Hsinchu (TW)

(72) Inventors: Pei-Yin CHEN, Taichung City (TW); Chun-Ting CHEN, Taichung City (TW); Chien-Chih LIAO, Taichung City (TW)

(73) Assignee: INDUSTRIAL TECHNOLOGY RESEARCH INSTITUTE, Hsinchu (TW)

(21) Appl. No.: 18/397,669

(22) Filed: Dec. 27, 2023

(51) Int. Cl. G06F 30/23; G06F 113/24; G06F 119/02

(52) U.S. Cl. CPC G06F 30/23; G06F 2113/24; G06F 2119/02

(57) ABSTRACT

A strength prediction method for laser bonded composite materials includes the following steps: establishing an initial geometric model that includes an initial solid geometric model and an initial surface geometric model in contact with each other; receiving metal material information, non-metal material information and layer formation parameters; setting material property parameters of the initial solid geometric model according to the metal material information to generate a solid model; generating a layer model according to the non-metal material information and a layer thickness and a layer quantity that are included in the layer formation parameters; setting material property parameters of the initial surface geometric model according to the layer model to generate a surface model; setting connection between the solid model and the surface model as laser bonding to generate a composite structural model; and performing a tensile test simulation to the composite structural model to obtain a simulation result.

### TECHNICAL FIELD

The present disclosure relates to a strength prediction method, more particularly to a strength prediction method for laser bonded composite materials.

### BACKGROUND

Most machine tools are predominantly made of metal. In an effort to reduce energy consumption during machine tool operation and consequently lower carbon emissions, some developers are experimenting with the utilization of composite materials that combine both metal and non-metal for manufacturing machine tools.

However, during the design of machine tools, accurately obtaining the strength of composite materials combining both metal and non-metal is challenging. This lack of clarity can result in the manufactured machine tool according to the initial design being either insufficiently strength, leading to increased susceptibility to damage, or excessively sturdy, making weight reduction difficult and consequently maintaining high energy consumption.

### SUMMARY

The present disclosure provides a strength prediction method aimed at enhancing the simulation accuracy regarding the bonding strength of composite materials that combine both metal and non-metal, so that the convenience of designing machine tools is facilitated.

According to one aspect of the present disclosure, a strength prediction method for laser bonded composite materials, performed by a computing device, includes the following steps: establishing an initial geometric model, wherein the initial geometric model includes an initial solid geometric model and an initial surface geometric model that are in contact with each other; receiving metal material information, non-metal material information and a plurality of layer formation parameters; setting material property parameters of the initial solid geometric model according to the metal material information to generate a solid model; generating a layer model according to the non-metal material information and the plurality of layer formation parameters, wherein the plurality of layer formation parameters comprise at least one layer thickness and a layer quantity; setting material property parameters of the initial surface geometric model according to the layer model to generate a surface model; setting connection between the solid model and the surface model as laser bonding to generate a composite structural model; and performing a tensile test simulation to the composite structural model to obtain a simulation result.

According to the strength prediction method for laser bonded composite materials discussed above, through the establishment of the initial geometric model including the initial solid geometric model and the initial surface geometric model, it is possible to perform the tensile test simulation to the composite structural model from laser bonded metal and non-metal so as to obtain more accurate bonding strength of composite materials combining both metal and non-metal than convention in the design stage, thereby facilitating the manufactured products according to the design with appropriate strength and preventing under-design or over-design in strength.

### BRIEF DESCRIPTION OF THE DRAWINGS

The present disclosure will become more fully understood from the detailed description given hereinbelow and the accompanying drawings which are given by way of illustration only and thus are not intending to limit the present disclosure and wherein:

FIG. 1 to FIG. 4 are flow charts of a strength prediction method for laser bonded composite materials according to one embodiment of the present disclosure;

FIG. 5 to FIG. 8 are schematic views of a strength prediction method for laser bonded composite materials according to one embodiment of the present disclosure;

FIG. 9 is a schematic view showing the stacking of initial layers in a strength prediction method for laser bonded composite materials according to one embodiment of the present disclosure;

FIG. 10 is a chart showing a simulation result by a strength prediction method for laser bonded composite materials according to one embodiment of the present disclosure; and

FIG. 11 is a chart showing an updated simulation result by a strength prediction method for laser bonded composite materials according to one embodiment of the present disclosure.

### DETAILED DESCRIPTION

Aspects and advantages of the invention will become apparent from the following detailed descriptions with the accompanying drawings. For purposes of explanation, one or more specific embodiments are given to provide a thorough understanding of the invention, and which are described in sufficient detail to enable one skilled in the art to practice the described embodiments. It should be understood that the following descriptions are not intended to limit the embodiments to one specific embodiment. On the contrary, it is intended to cover alternatives, modifications, and equivalents as can be included within the spirit and scope of the described embodiments as defined by the appended claims.

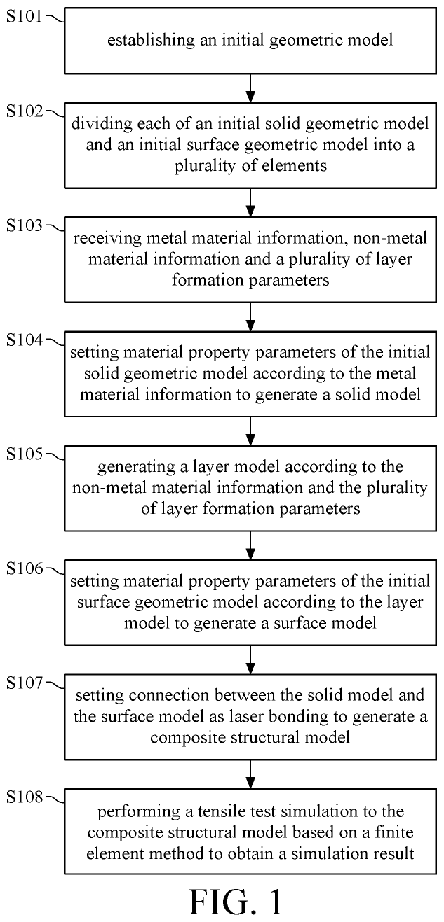

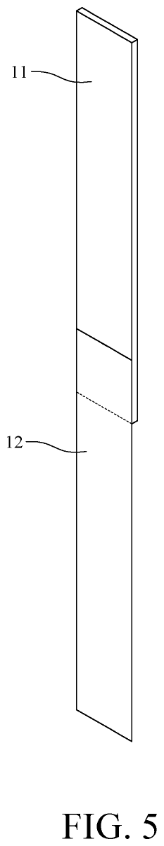

Please refer to FIG. 1 to FIG. 8, where FIG. 1 to FIG. 4 are flow charts of a strength prediction method for laser bonded composite materials according to one embodiment of the present disclosure, and FIG. 5 to FIG. 8 are schematic views of a strength prediction method for laser bonded composite materials according to one embodiment of the present disclosure.

As shown in FIG. 1, a strength prediction method for laser bonded composite materials provided in the present disclosure may include step S101: establishing an initial geometric model; step S102: dividing each of an initial solid geometric model and an initial surface geometric model into a plurality of elements; step S103: receiving metal material information, non-metal material information and a plurality of layer formation parameters; step S104: setting material property parameters of the initial solid geometric model according to the metal material information to generate a solid model; step S105: generating a layer model according to the non-metal material information and the plurality of layer formation parameters; step S106: setting material property parameters of the initial surface geometric model according to the layer model to generate a surface model; step S107: setting connection between the solid model and the surface model as laser bonding to generate a composite structural model; and step S108: performing a tensile test simulation to the composite structural model based on a finite element method to obtain a simulation result.

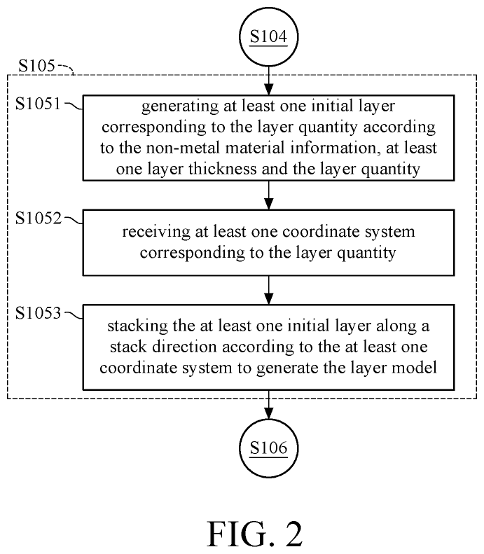

As shown in FIG. 2, the step S105 may include step S1051: generating at least one initial layer corresponding to the layer quantity according to the non-metal material information, at least one layer thickness and the layer quantity; step S1052: receiving at least one coordinate system corresponding to the layer quantity; and S1053: stacking the at least one initial layer along a stack direction according to the at least one coordinate system to generate the layer model.

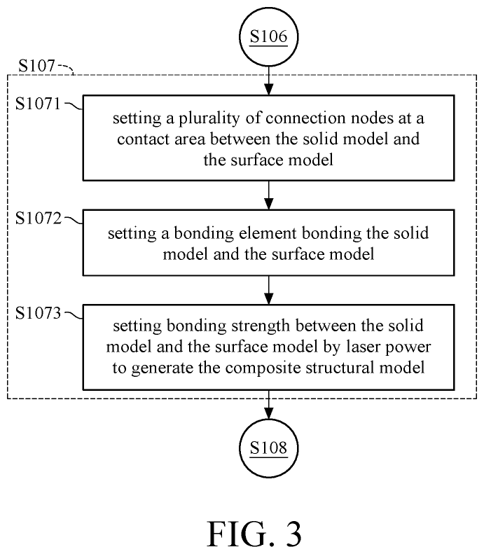

As shown in FIG. 3, the step S107 may include step S1071: setting a plurality of connection nodes at a contact area between the solid model and the surface model; step S1072: setting a bonding element bonding the solid model and the surface model; and step S1073: setting bonding strength between the solid model and the surface model by laser power to generate the composite structural model.

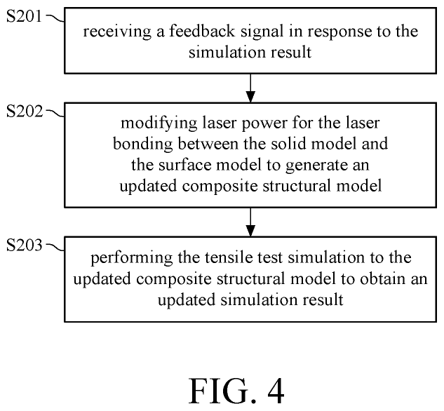

As shown in FIG. 4, the strength prediction method for laser bonded composite materials provided in the present disclosure may further include step S201: receiving a feedback signal in response to the simulation result; step S202: modifying laser power for the laser bonding between the solid model and the surface model to generate an updated composite structural model; and step S203: performing the tensile test simulation to the updated composite structural model to obtain an updated simulation result.

In the following, the strength prediction method for laser bonded composite materials provided in the present disclosure will be illustrated through exemplary performance using a computing device, such as a central processing unit (CPU) of a computer, with the reference of FIG. 1 to FIG. 4 and FIG. 5 to FIG. 8.

In the step S101, as shown in FIG. 5, the computing device establishes an initial geometric model 10. The initial geometric model 10 includes an initial solid geometric model 11 and an initial surface geometric model 12 that are in contact with each other. The initial solid geometric model 11 may be, for example, a component having three dimensional sizes with a certain degree of thickness. Please note that the shape of the initial solid geometric model 11 shown as a rectangular block in FIG. 5 is only exemplary. In some embodiments of the present disclosure, the initial solid geometric model may be any suitable shape, and the present disclosure is not limited thereto. The initial surface geometric model 12 may be, for example, a component having three dimensional sizes with an extremely small thickness. Please note that the initial surface geometric model 12 with the extremely small thickness is exemplarily shown as a flat sheet in FIG. 5, but the present disclosure is not limited thereto. In some other embodiments of the present disclosure, the initial surface geometric model may have a curved shape in the three dimensional space. The abovementioned contact between the initial solid geometric model 11 and the initial surface geometric model 12 can be considered that the initial solid geometric model 11 and the initial surface geometric model 12 are gently lean on each other without any connection involving a bonding force.

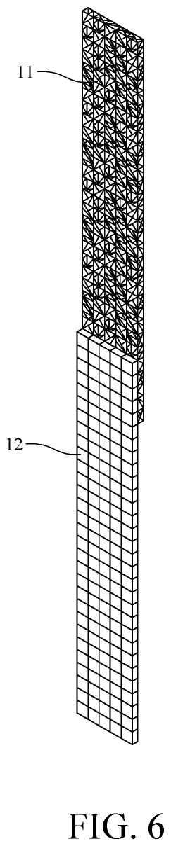

In step S102, as shown in FIG. 6, the computing device divides each of the initial solid geometric model 11 and the initial surface geometric model 12 into a plurality of elements. In FIG. 6, the initial solid geometric model 11 is divided into a plurality of hexahedral elements, and the initial surface geometric model 12 is divided into a plurality of quadrilateral elements. However, the present disclosure is not limited thereto. In some embodiments of the present disclosure, the initial solid geometric model may be divided into any suitable kind of polyhedral elements. In some other embodiments of the present disclosure, the initial surface geometric model may be divided into any suitable kind of polygonal elements. Moreover, please be noted that the elements of the initial surface geometric model 12 under the division may be considered to have an upper layer and a lower layer within the extremely small thickness for facilitating the arrangement of nodes used in future computation. Therefore, the initial surface geometric model 12 shown in FIG. 6 is visualized with a certain degree of thickness for presenting the upper layer and the lower layer under the division, but the initial surface geometric model 12 in fact remains a component with an extremely small thickness. It can be also considered that the step S102 does not change the thickness of the initial surface geometric model 12.

In the step S103, the computing device receives metal material information, non-metal material information and a plurality of layer formation parameters, wherein the metal material information, the non-metal material information and the layer formation parameters may be input into the computer via an input device, such as a mouse or a keyboard of the computer, for facilitating the receiving by the computing device. Moreover, the layer formation parameters may include the quantity and at least one thickness of the layer(s) to be formed (corresponding to an initial layer in the following description).

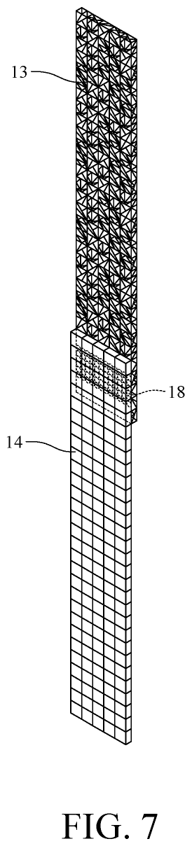

In step S104, as shown in FIG. 7, the computing device generates a solid model 13 by setting the material property parameters of the initial solid geometric model 11 according to the received metal material information through the utilization of corresponding metal material property parameters that may be pre-stored within a storage device, such as a hard disk of the computer. For example, if the received metal material information input via the input device in the step S103 is iron (Fe), the computing device can search the iron-related characteristic parameters pre-stored within the hard disk, such as the Young's modulus and the Poisson's ratio thereof, and then the computing device can apply the iron-related characteristic parameters to the initial solid geometric model 11 so as to generate the solid model 13. However, the present disclosure is not limited thereto. In some embodiments of the present disclosure, the received metal material information input via the input device may be just the Young's modulus and the Poisson's ratio of the metal (e.g., iron), and the computing device can directly set the material property parameters of the initial solid geometric model based on the received Young's modulus and Poisson's ratio of the metal.

In the step S105, the computing device generates a layer model according to the received non-metal material information and the layer formation parameters.

Specifically, the step S105 may include the step S1051 to the step S1053. In the step S1051, the computing device generates initial layer(s) according to the received non-metal material information as well as at least one layer thickness and a layer quantity that are included in the layer formation parameters with the correspondence between the quantity of the initial layer(s) and the layer quantity. Please note that the layer quantity may be a positive integer such as 1, 2, 3 or more, and the quantity of the initial layer(s) is the same as the positive integer (i.e., one, two, three or more initial layers are generated). Also, the thickness of single layer of the initial layer(s) corresponds to one of the at least one layer thickness. For example, if the layer thickness and the layer quantity included in the layer formation parameters may be 0.09 millimeters (mm) and 4, respectively, the computing device can generate four initial layers with the thickness of 0.09 mm in each layer. In another example, if the layer thicknesses are 0.09 mm, 0.08 mm, 0.09 mm and 0.08 mm, and the layer quantity is 4, the computing device can generate four initial layers with the thicknesses of 0.09 mm, 0.08 mm, 0.09 mm and 0.08 mm in respective layers. Moreover, the material property parameters of the initial layer(s) can correspond to the non-metal material information and may be obtained through the corresponding non-metal material property parameters that may be pre-stored within a storage device, such as a hard disk of the computer. For example, if the received non-metal material information input via the input device in the step S103 is carbon fiber, the computing device can search the carbon-fiber-related characteristic parameters pre-stored within the hard disk, such as the Young's modulus and the Poisson's ratio thereof corresponding to the fiber angle, and then the computing device can apply the carbon-fiber-related characteristic parameters to the initial layer(s) during the generation of the initial layer(s). However, the present disclosure is not limited thereto. In some other embodiments of the present disclosure, the received non-metal material information input via the input device may be just the Young's modulus and the Poisson's ratio of the non-metal (e.g., carbon fiber) corresponding to the fiber angle, and the computing device can directly set the material property parameters of the initial layer(s) based on the received Young's modulus and Poisson's ratio of the non-metal corresponding to the fiber angle. Please note that in the case that the quantity of the initial layer(s) is plural, the initial layers can be generated at the same time or one after one, and the present disclosure is not limited thereto. In some embodiments of the present disclosure, the non-metal may be epoxy resin.

In the step S1052, the computing device receives at least one coordinate system corresponding to the layer quantity. For example, if the layer quantity is 4, the computing device may receive four coordinate systems that respectively correspond to the four initial layers.

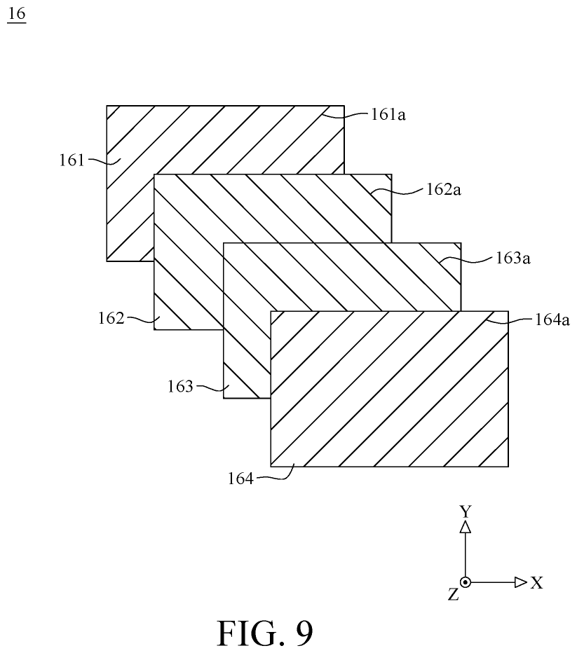

In the step S1053, the computing device stacks the initial layer(s) along a stack direction according to the at least one coordinate system so as to generate the layer model. For example, please refer to FIG. 9, which is a schematic view showing the stacking of initial layers in a strength prediction method for laser bonded composite materials according to one embodiment of the present disclosure. In FIG. 9, the stack direction may be the positive Z-axis direction of a global system shown in FIG. 9, and the positive X-axis directions of the four coordinate systems may be angled to the positive X-axis direction of the global system by, for example, 45 degrees, 135 degrees, 135 degrees and 45 degrees, respectively. The computing device stacks corresponding four initial layers 161, 162, 163, 164 along the positive Z-axis direction sequentially at respective angles of 45 degrees, 135 degrees, 135 degrees, and 45 degrees relative to the global system so as to form the layer model 16. In FIG. 9, the four initial layers 161, 162, 163, 164 may be made of carbon fiber, and their respective fibers 161a, 162a, 163a, 164a each have a fiber angle extending along a direction in parallel to, for example, the X-axis of their respective coordinate system. Therefore, the initial layers 161, 162, 163, 164 may be stacked along the positive Z-axis direction with the extension directions of the fibers 161a, 162a, 163a, 164a angled to the X-axis of the global system by 45 degrees, 135 degrees, 135 degrees, and 45 degrees, respectively. Please note that the angle(s) in stacking the initial layer(s) with respect to the global system is not intended to limit the present disclosure. In some embodiments of the present disclosure, one initial layer may be stacked with a relative angle with respect to the adjacent stacked initial layer. In some other embodiments of the present disclosure, the initial layer(s) may be stacked with the corresponding coordinate system(s) aligned with the coordinate system of the global system (it can also be considered that the stacking is processed in a manner that all positive X-axis directions of all coordinate systems are aligned), with their respective fibers extend along different directions. Please note that the angles between the extension directions of the fibers 161a, 162a, 163a, 164a and the X-axes of the corresponding coordinate systems are not intended to limit the present disclosure. In some embodiments of the present disclosure, the angle between the extension direction of the fiber of single initial layer and the X-axis of the corresponding coordinate system may be any suitable angle. Moreover, the stacked initial layers may have different fiber angles. Taking FIG. 9 as an example, the fiber angle of the fiber 161a of the initial layer 161 and the fiber angle of the fiber 162a of the initial layer 162 differ by 90 degrees, while the fiber angle of the fiber 161a of the initial layer 161 is the same as the fiber angle of the fiber 164a of the initial layer 164.

In the step S106, as shown in FIG. 7, the computing device generates a surface model 14 by setting the material property parameters of the initial surface geometric model 12 according to the layer model generated in the step S105. Please note that the layer model 16 shown in FIG. 9 can be one aspect of the layer model used in the step S106, but the present disclosure is not limited thereto. Please note that the layer model generated in the step S105 may have different strength-related parameters due to the quantity of stacked initial layer(s) and the thickness of each stacked initial layer(s). For instance, increasing the quantity of stacked initial layer(s) or the thickness of each initial layer results in enhancing the strength-related parameters of the layer model obtains. In the step S106, the strength-related parameters derived from the stacked layer model in the step S105 are assigned as the material property parameters of the initial surface geometric model 12. The strength-related parameters do not incorporate the thickness of the layer model, ensuring the surface model 14 generated in the step S106 remains at the extremely small thickness. The surface model 14 with a certain degree of thickness shown in FIG. 7, as set forth, is visualized for presenting the element division.

In the step S107, the computing device sets the connection between the solid model 13 and the surface model 14 as laser bonding so as to generate a composite structural model 20.

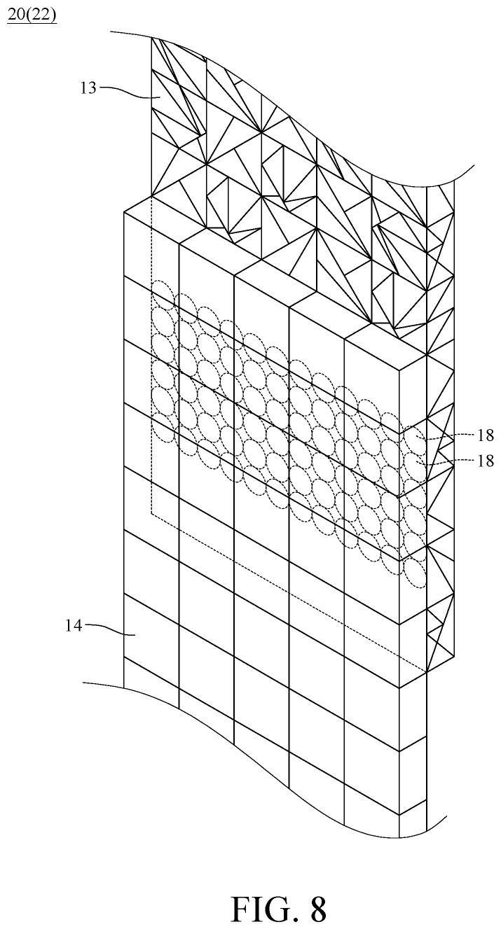

Specifically, the step S107 may include the step S1071 to the step S1073. In the step S1071, as shown in FIG. 7 and FIG. 8, the computing device sets a plurality of connection nodes 18 at the contact area between the solid model 13 and the surface model 14, wherein adjacent two of the connection nodes 18 are spaced apart from each other by an interval. Please refer to FIG. 8 for detail. The quantity of the connection nodes 18 may be 72. The connection nodes 18 may be equidistantly arranged by the interval ranging from 2 mm to 2.5 mm to form a matrix of 25 mm×12.5 mm within the contact area of 25 mm×25 mm. The matrix may have twelve connection nodes 18 at its long side of 25 mm and six connection nodes 18 at its short side of 12.5 mm, and the matrix arranged by the connection nodes 18 may be spaced apart from the boundary of the contact area by 6.25 mm at both sides along a direction in parallel with the short side thereof. Please note that the interval of the connection nodes 18 is not intended to limit the present disclosure. In some embodiments of the present disclosure, the connection nodes may be arranged by any suitable interval or unequal intervals.

In the step S1072, the computing device sets a bonding element bonding the solid model 13 and the surface model 14, wherein the bonding element may be set as a spring (e.g., an extension spring). Therefore, the characteristic of the spring can be utilized to perform the following simulation. Please note that the setting of the bonding element is not intended to limit the present disclosure, and the bonding element may be set as any suitable bonding type.

In the step S1073, the computing device sets the bonding strength between the solid model 13 and the surface model 14 by laser power to generate the composite structural model 20. Accordingly, the composite structural model 20 from laser bonded metal and non-metal is generated by the computing device.

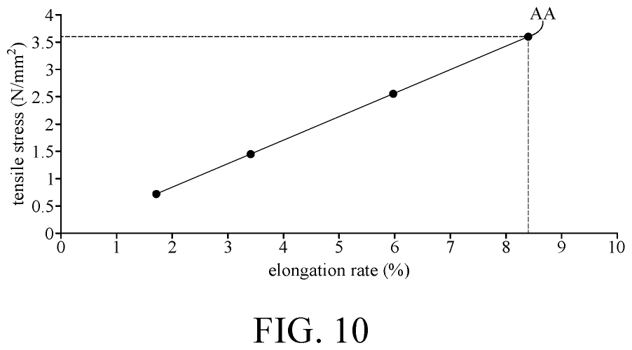

In the step S108, the computing device can perform a tensile test simulation to the composite structural model 20 based on the finite element method that utilizes the plurality of elements of the initial geometric model 10 divided by the computing device in the step S102 so as to obtain a simulation result. The simulation result may refer to FIG. 10, which is a chart showing a simulation result by a strength prediction method for laser bonded composite materials according to one embodiment of the present disclosure. As shown at the point AA in FIG. 10, the composite structural model 20 can withstand the maximum tensile stress of 3.6 Newtons per square millimeter (N/mm²) with the maximum elongation rate of 8.4%. Please note that the simulation result shown in FIG. 10 may be an average simulation result from multiple times tensile test simulations performed on the same composite structural model 20 or may be single simulation result of single tensile test simulation performed on the composite structural model 20, and the present disclosure is not limited thereto.

Then, the computing device can display the simulation result through a display device, such as a displayer of the computer. The user can determine whether the simulation result displayed on the display device meets design requirements. If the user determines that the simulation result does not meet the design requirements (for example, the slope of the line in FIG. 10 needs to be reduced), the user can input a feedback signal in response to the abovementioned simulation result through the input device. Then, in the step S201, the computing device receives the abovementioned feedback signal.

In the step S202, the computing device can modify the laser power for the laser bonding between the solid model 13 and the surface model 14 based on the abovementioned feedback signal so as to generate an updated composite structural model 22. For example, in order to reduce the slope of the line showing the simulation result in FIG. 10, the computing device can modify the laser power to 0.9 times of its original setting without modification to other settings related to the connection nodes or the bonding element. Please note that the computing device can modify one or more among the laser power, the connection nodes and the bonding element, and the present disclosure is not limited thereto.

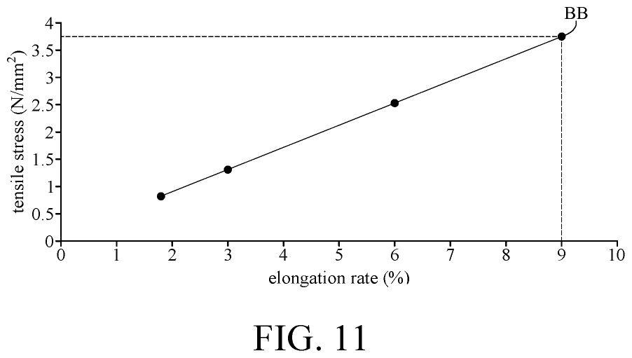

In the step S203, the computing device performs the tensile test simulation to the updated composite structural model 22 so as to obtain an updated simulation result. The simulation result may refer to FIG. 11, which is a chart showing an updated simulation result by a strength prediction method for laser bonded composite materials according to one embodiment of the present disclosure. As shown at the point BB in FIG. 11, the updated composite structural model 22 can withstand the maximum tensile stress of 3.75 Newtons per square millimeter (N/mm²) with the maximum elongation rate of 9.0%. Please note that the updated simulation result shown in FIG. 11 may be an average updated simulation result from multiple times tensile test simulations performed on the same updated composite structural model 22 or may be single updated simulation result of single tensile test simulation performed on the updated composite structural model 22, and the present disclosure is not limited thereto.

Similarly, the user can determine whether the updated simulation result displayed on the display device meets design requirements, and the user can selectively input the feedback signal for performing the step S201 to step S203 again. Please note the simulation result or the updated simulation result meeting the design requirements or not may be alternatively determined by a determination device, which can accordingly selectively send out a feedback signal, and the present disclosure is not limited thereto.

Please note that the order of the abovementioned steps is not intended to limit the present disclosure. In some embodiments of the present disclosure, the step S104 may be performed after the step S105. In some other embodiments of the present disclosure, the steps S101 to S102 may be performed after the steps S103 to S105. In some other embodiments of the present disclosure, the steps S101 to S102 and the steps S103 to S105 may be performed at the same time.

According to the strength prediction method for laser bonded composite materials discussed above, through the establishment of the initial geometric model including the initial solid geometric model and the initial surface geometric model, it is possible to perform the tensile test simulation to the composite structural model from laser bonded metal and non-metal so as to obtain more accurate bonding strength of composite materials combining both metal and non-metal than convention in the design stage, thereby facilitating the manufactured products according to the design with appropriate strength and preventing under-design or over-design in strength.

The embodiments are chosen and described in order to best explain the principles of the present disclosure and its practical applications, to thereby enable others skilled in the art best utilize the present disclosure and various embodiments with various modifications as are suited to the particular use being contemplated. It is intended that the scope of the present disclosure is defined by the following claims and their equivalents.

What is claimed is:

1. A strength prediction method for laser bonded composite materials, performed by a computing device, comprising:
establishing an initial geometric model, wherein the initial geometric model comprises an initial solid geometric model and an initial surface geometric model that are in contact with each other;
receiving metal material information, non-metal material information and a plurality of layer formation parameters;
setting material property parameters of the initial solid geometric model according to the metal material information to generate a solid model;
generating a layer model according to the non-metal material information and the plurality of layer formation parameters, wherein the plurality of layer formation parameters comprise at least one layer thickness and a layer quantity;
setting material property parameters of the initial surface geometric model according to the layer model to generate a surface model;
setting connection between the solid model and the surface model as laser bonding to generate a composite structural model; and
performing a tensile test simulation to the composite structural model to obtain a simulation result.

2. The strength prediction method for laser bonded composite materials according to claim 1, further comprising:
dividing each of the initial solid geometric model and the initial surface geometric model into a plurality of elements.

3. The strength prediction method for laser bonded composite materials according to claim 1, wherein the material property parameters of the initial solid geometric model comprises a Young's modulus and a Poisson's ratio.

4. The strength prediction method for laser bonded composite materials according to claim 1, wherein the non-metal material information is carbon fiber, and the material property parameters of the initial surface geometric model comprises a fiber angle, a Young's modulus and a Poisson's ratio.

5. The strength prediction method for laser bonded composite materials according to claim 4, wherein generating the layer model according to the non-metal material information and the plurality of layer formation parameters comprises:
generating at least one initial layer corresponding to the layer quantity according to the non-metal material information, at least one layer thickness and the layer quantity, wherein material property parameters of the at least one initial layer correspond to the non-metal material information, and a thickness of each of the at least one initial layer corresponds to one of the at least one layer thickness;
receiving at least one coordinate system corresponding to the layer quantity; and
stacking the at least one initial layer along a stack direction according to the at least one coordinate system to generate the layer model.

6. The strength prediction method for laser bonded composite materials according to claim 5, wherein a quantity of the at least one initial layer is plural, and at least two of the initial layers that have been stacked are different in fiber angle.

7. The strength prediction method for laser bonded composite materials according to claim 1, wherein setting the connection between the solid model and the surface model as the laser bonding to generate the composite structural model comprises:
setting a plurality of connection nodes at a contact area between the solid model and the surface model, wherein adjacent two of the plurality of connection nodes are spaced apart from each other by an interval;
setting a bonding element bonding the solid model and the surface model; and
setting bonding strength between the solid model and the surface model by laser power to generate the composite structural model.

8. The strength prediction method for laser bonded composite materials according to claim 7, wherein the bonding element is set as a spring.

9. The strength prediction method for laser bonded composite materials according to claim 1, further comprising:
receiving a feedback signal in response to the simulation result;
modifying laser power according to the feedback signal for the laser bonding between the solid model and the surface model to generate an updated composite structural model; and
performing the tensile test simulation to the updated composite structural model to obtain an updated simulation result;
wherein the updated simulation result comprises a tensile stress and an elongation rate of the updated composite structural model.

10. The strength prediction method for laser bonded composite materials according to claim 1, wherein performing the tensile test simulation to the composite structural model to obtain the simulation result comprises:
performing the tensile test simulation to the composite structural model based on a finite element method to obtain the simulation result.
